(19) United States
(12) Patent Application Publication
(10) Pub. No.: US 2024/0030557 A1
(43) Pub. Date: Jan. 25, 2024

(54) CONTACT INTERFACE FOR ELECTRICALLY COUPLING BATTERY CELLS

(71) Applicant: Molex, LLC, Lisle, IL (US)

(72) Inventor: Ronald C Hodge, Montgomery, IL (US)

(21) Appl. No.: 18/265,676

(22) PCT Filed: Jan. 14, 2022
(86) PCT No.: PCT/IB2022/050301

§ 371 Date: Jun. 7, 2023

Related U.S. Application Data
(60) Provisional application No. 63/137,442, filed on Jan. 14, 2021.

(51) Int. Cl. H01M 50/503; H01M 50/514; H01M 50/209

(52) U.S. Cl. CPC H01M 50/503; H01M 50/514; H01M 50/209

(57) ABSTRACT

A contact interface is configured to be coupled to a pair of batteries. The contact interface includes a bracket, a conductive terminal contact plate and a biasing member provided between the bracket and the terminal contact plate. The bracket includes a base and a pair of legs extending from opposite ends thereof. Each leg has an engagement which is configured to be coupled to an engagement on each of the batteries. The terminal contact plate is configured to be in contact with terminals on the batteries. The biasing member biases the terminal contact plate into contact with the terminals.

### RELATED APPLICATIONS

This application claims priority to U.S. Provisional Application No. 63/137,442 filed Jan. 14, 2021, which is incorporated herein by reference.

### FIELD OF THE DISCLOSURE

The present disclosure is directed to a contact interface for electrically coupling pairs of battery cells together. More specifically, this disclosure relates to a contact interface for electrically coupling pairs of battery cells together that can be removed from the pairs of battery cells.

### DESCRIPTION OF RELATED ART

An electric-vehicle battery (EVB) (also known as a traction battery) is a battery used to power an electric motor of a battery electric vehicle (BEV) or hybrid electric vehicle (HEV). These batteries are usually rechargeable (secondary) batteries and are typically lithium-ion batteries. These batteries are specifically designed for a high ampere-hour (or kilowatt-hour) capacity.

EVBs differ from starting, lighting, and ignition (SLI) batteries as they are designed to give power over sustained periods of time and are deep-cycle batteries. Batteries for electric vehicles are characterized by their relatively high power-to-weight ratio, specific energy and energy density. Smaller, lighter batteries are desirable because they reduce the weight of the vehicle and therefore improve its performance. Compared to liquid fuels, most current battery technologies have much lower specific energy, and this often impacts the maximum all-electric range of the vehicles.

The battery pack makes up a significant cost of a BEV or a HEV. In terms of operating costs, the price of electricity to run a BEV is a small fraction of the cost of fuel for equivalent internal combustion engines, reflecting higher energy efficiency.

Battery pack designs for Electric Vehicles (EVs) are complex and vary widely by manufacturer and specific application. However, they all incorporate a combination of several simple mechanical and electrical component systems which perform the basic required functions of the pack.

The actual battery cells can have different chemistry, physical shapes, and sizes as preferred by various pack manufacturers. Battery packs will always incorporate many discrete battery cells connected in series and parallel to achieve the total voltage and current requirements of the pack. Battery packs for all electric drive EVs can contain several hundred individual battery cells. Each battery cell has a nominal voltage of 3-4 volts, depending on its chemical composition.

To assist in manufacturing and assembly, the large stack of battery cells is typically grouped into smaller stacks called modules. Several of these modules will be placed into a single pack. Within each module the battery cells are welded together to complete the electrical path for current flow.

Modules can also incorporate cooling mechanisms, temperature monitors, and other devices. In most cases, modules also allow for monitoring the voltage produced by each battery cell in the stack by using a Battery Management System (BMS).

Electric vehicle batteries which are in the end-of-life stage (having reduced power capacity and no longer being suitable for powering electric vehicles) can be reused for second-life applications such as use in e-bus power packs, backups for large buildings, use in home energy storage, supply stabilization for solar and wind power generators, backup power for telecom base stations and data centers, the powering of fork lifts, electric scooters and bikes, etc. Individual batteries are usually arranged into large battery packs of various voltage and ampere hour capacity products to give the required energy capacity. Battery service life should be considered when calculating the extended cost of ownership, as all batteries eventually wear out and must be replaced.

### BRIEF SUMMARY

Accordingly, in an embodiment, the present disclosure provides a contact interface is configured to be coupled to a pair of batteries. The contact interface includes a bracket, a conductive terminal contact plate and a biasing member provided between the bracket and the terminal contact plate. The bracket includes a base and a pair of legs extending from opposite ends thereof. Each leg has an engagement which is configured to be coupled to an engagement on each of the batteries. The terminal contact plate is configured to be in contact with terminals on the batteries. The biasing member biases the terminal contact plate into contact with the terminals.

### BRIEF DESCRIPTION OF THE DRAWINGS

The present disclosure is illustrated by way of example, and not limited, in the accompanying figures in which like reference numerals indicate similar elements and in which:

FIG. 1 depicts a perspective view of an assembly of a pair of battery cells, a contact interface and a pair of retention members which incorporates features of the present disclosure;

FIG. 2 depicts a perspective view of a battery cell;

FIG. 3 depicts a perspective view of the contact interface and retention members; and

FIG. 4 depicts a side elevation view of the contact interface and retention members.

### DETAILED DESCRIPTION

The appended drawings illustrate embodiments of the present disclosure and it is to be understood that the disclosed embodiments are merely exemplary of the disclosure, which may be embodied in various forms. Therefore, specific details disclosed herein are not to be interpreted as limiting, but merely as a basis for the claims and as a representative basis for teaching one skilled in the art to variously employ the present disclosure.

This present disclosure provides a contact interface 20 which electrically couples pairs of battery cells 22 to form an assembly 24, and can be disengaged from the pairs of battery cells 22 without damaging the battery cells 22. This allows for the battery cells 22 to have a second-life use or be replaced in the assembly 24. The contact interface 20 is shown primarily for use with prismatic battery cells, however the disclosure is not limited to such types of battery cells. For example, pouch-type battery cell may be provided for use with the contact interface 20.

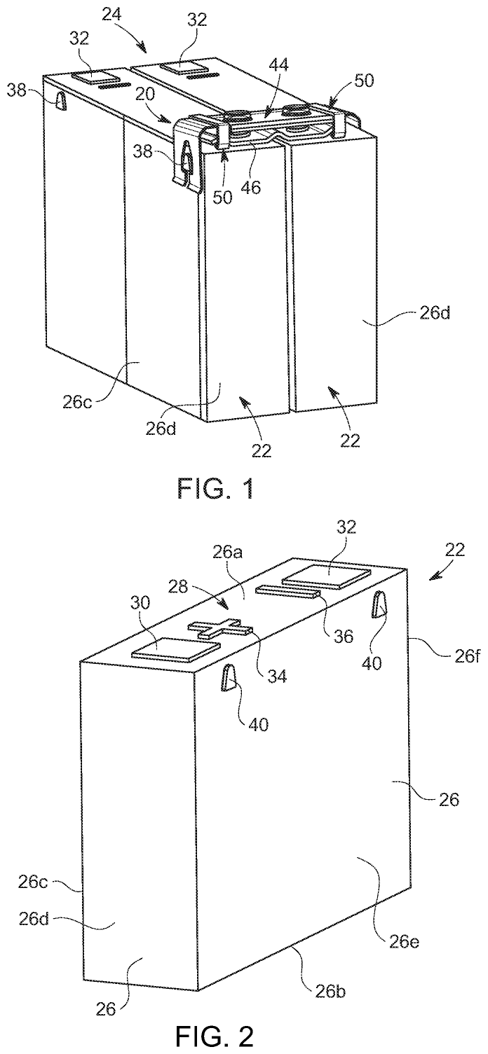

A prismatic style battery cell is depicted in FIGS. 1 and 2. Prismatic battery cells are known in the art and satisfy the demand for thinner sizes of battery cells. The battery cell 22 includes a package 26 resembling a box of chewing gum or a small chocolate bar having a top surface 26a, an opposite bottom surface 26b, and side surfaces 26c, 26d, 26e, 26f extending therebetween. A terminal area 28 is generally located on the top surface 26a, and typically includes positive and negative terminals 30, 32 and may include indicators 34, 36 (e.g., positive (+) or negative (−)). In some embodiments, top surfaces of the positive and negative terminals 30, 32 are raised from the top surface 26a of the package 26. The positive and negative terminals 30, 32 provide positive and negative polarities on each battery cell 22. Each battery cell 22 has a pair of engagements 38 formed on the side surface 26c proximate to the positive and negative terminals 30, 32, and a pair of engagements 40 formed on the side surface 26e proximate to the positive and negative terminals 30, 32. The engagements 38, 40 may be vertically aligned. In an embodiment, only one engagement is provided on each battery cell 22; for example engagement 38 proximate to the positive terminal 30 on a first battery cell 22 and engagement 40 proximate to the positive terminal 30 on a second battery cell 22; or for example engagement 38 proximate to the positive terminal 30 on a first battery cell 22 and engagement 38 proximate to the negative terminal 30 on a second battery cell 22. In an embodiment, only two of the engagements are provided on each battery cell 22; for example engagements 38 proximate to the positive and negative terminals 30, 32 on a first battery cell 22 and engagements 38 proximate to the positive and negative terminals 30, 32 on a second battery cell 22.

A prismatic battery cell makes optimal use of space by using a layered approach. Other battery cells are wound and flattened into a pseudo-prismatic jelly roll. These battery cells are predominantly found in mobile phones, tablets and low-profile laptops ranging from 800 mAh to 4,000 mAh. A universal format does not exist and each manufacturer designs its own. Prismatic battery cells are also available in large formats. Packaged in welded aluminum housings, the battery cells deliver capacities of 20-50 Ah and are primarily used for electric powertrains in hybrid and electric vehicles. The battery pouch battery cell offers a simple, flexible and lightweight solution to battery design. Some stack pressure is recommended but allowance for swelling must be made. The pouch battery cells can deliver high load currents but they perform best under light loading conditions and with moderate charging. The pouch battery cell makes most efficient use of space and achieves 90-95 percent packaging efficiency, the highest among battery packs. Eliminating the metal enclosure reduces weight, but the battery cells need support and allowance to expand in the battery compartment. The pouch packs are used in consumer, military and automotive applications.

In use, multiple battery cells 22 are connected together by multiple contact interfaces to form a battery module which establishes the main power source for the EV vehicle. The battery cells 22 can be coupled in series in which the positive terminal 30 of a first battery cell 22 is coupled to the negative terminal 32 of an adjacent second battery cell 22 by a contact interface 20, and the positive terminal 30 of the second battery cell 22 is coupled to the negative terminal 32 of an adjacent third battery cell 22 by a contact interface 20, and the positive terminal 30 of the third battery cell 22 is coupled to the negative terminal 32 of an adjacent fourth battery cell 22 by a contact interface 20, and so on, to form the battery module. In an embodiment, some of the battery cells 22 are coupled in parallel through their positive terminals 30 by a contact interface 20 in the battery module. For example, the positive terminal of a first battery cell 22 is coupled to the positive terminal 30 of an adjacent second battery cell 22 by a contact interface 20, and the negative terminal 32 of the second battery cell 22 is coupled to the positive terminal 30 of an adjacent third battery cell 22 by a contact interface and the negative terminal 32 of the third battery cell 22 is coupled to the positive terminal of an adjacent fourth battery cell 22 by a contact interface 20, and so on, to form the battery module. In an embodiment, only first and second battery cells 22 are provided to form the battery module and are coupled by their positive terminals 30 by a contact interface 20.

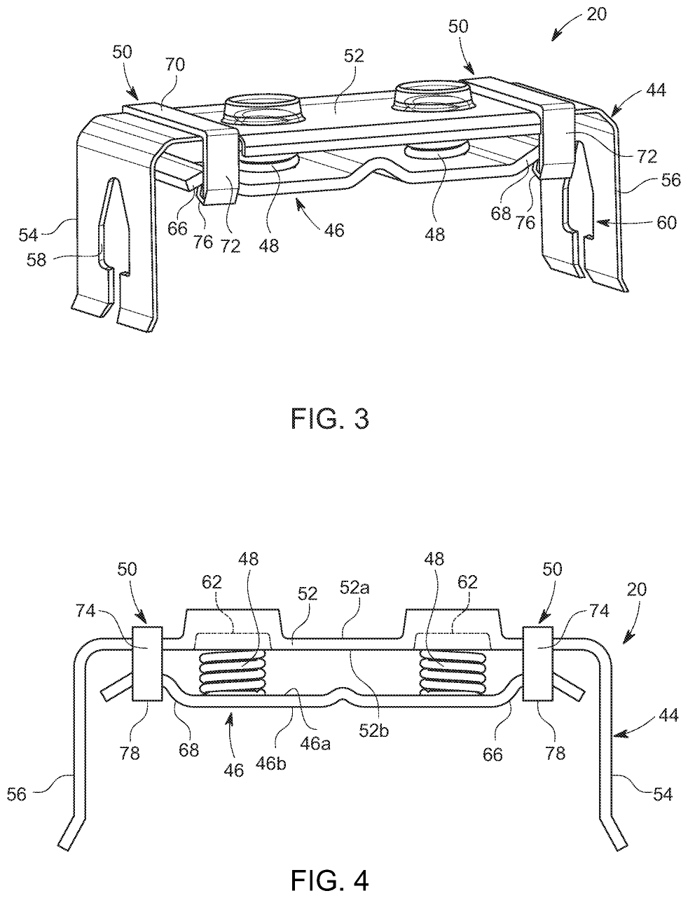

As best shown in FIGS. 3 and 4, the contact interface 20 includes a bracket 44, an electrically conductive terminal contact plate 46, and one or more biasing members 48 provided between the bracket 44 and the terminal contact plate 46. One or more retention members 50 are used to hold the bracket 44, the terminal contact plate 46, and the one or more biasing members 48, together.

The bracket 44 is generally “U” shaped having a horizontal base 52 that is long enough to span a pair of adjacent battery cells 22, and legs 54, 56 depending from the opposite ends of the horizontal base 52. The bracket 44 may be formed of metal, however, other materials such as molded plastic are contemplated. The horizontal base 52 has an upper surface 52a and an opposite lower surface 52b which are planar, or substantially planar. Each leg 54, 56 includes an engagement 58, 60. The engagements 38, 40 on the battery cells 22 are formed in the same configuration as the engagements 58, 60 such that the bracket 44 can be secured to the adjacent battery cells 22 by mating of the engagements 38, 40 and the engagements 58, 60. In an embodiment, the engagements 38, 40 on the battery cells 22 are projections extending outward from the side surfaces 26c, 26e of the package 26, and the engagements 58, 60 on the bracket 44 are cutouts which mirror or generally mirror the shape of the projections. Alternatively, the engagements 38, 40 on the battery cells 22 are recesses in the side surfaces 26c, 26e of the package 26, and the engagement 58, 60 on the bracket 44 are projections extending from the legs 54, 56 and which mirror or generally mirror the shape of the recesses. In some embodiments, the bracket 44 can be attached to the pair of battery cells 22 without the use of tools. In some embodiments, when the bracket 44 is attached to two of the battery cells 22, the engagements 58, 60 on the bracket 44 snap fit with the appropriate engagements 38, 40 on the battery cells 22. The lower surface 52b of the horizontal base 52 may have at least one recess 62 formed therein that is used to locate and maintain the position of the at least one biasing member 48 between the bracket 44 and the terminal contact plate 46. The at least one recess 62 may be formed in an embossment(s) that extend upward from the upper surface 52b.

The conductive terminal contact plate 46 is preferably formed of aluminum, but may be made of copper to provide lower bulk resistance. The terminal contact plate 46 has an upper surface 46a and an opposite lower surface 46b which are planar, or substantially planar. Pairs of spaced apart indents 66, 68 may be provided in the lower surface 46b. The terminal contact plate 46 has a length which is less than the length of the horizontal base 52 of the bracket 44, and a width which is approximately the same as, or slightly less than, the width of the horizontal base 52 of the bracket 44. The upper surface 46a may have at least one recess (not shown) formed therein that are used to locate and maintain the position of the at least one biasing member 48 between the bracket 44 and the terminal contact plate 46.

The one or more biasing members 48 are preferably in the form of springs and, more preferably, are in the form of compression springs, but other styles could be used, e.g., formed strip, Bellville, etc. The one or more biasing members 48 may formed of metal or plastic. The one or more biasing members 48 may be compressible rubber. The at least one biasing member 48 seats between the lower surface 52b of the horizontal base 52 of the bracket 44 and the upper surface 46a of the terminal contact plate 46 and the at least one biasing members 48 biases the terminal contact plate 46 away from the horizontal base 52 of the bracket 44. The at least one biasing members 48 seat within the recess(es) 62, if provided, and seat with the recess(es) in the terminal contact plate 46, if provided.

The at least one retention member 50 attaches the terminal contact plate 46 and the one or more biasing members 48 to the bracket 44. As illustrated, a pair of retention members are partially wrapped around the bracket 44 and the terminal contact plate 46 with the at least one biasing member 48. In an embodiment, each retention member 50 is a generally “U” shaped substantially rigid clip having a horizontal base 70 that spans a width of the horizontal base 52 of the bracket 44, arms 72, 74 depending from the opposite ends of the horizontal base and fingers 76, 78 extending toward each other. The fingers 76, 78 engage the lower surface 46b of the terminal contact plate 46 and may seat within the indents 66, 68 if provided. In an embodiment, each retention member 50 is a strip of material wrapped around the upper surface 52a of the horizontal base 52 of the bracket 44 and the lower surface 46b of the terminal contact plate 46 and secured to itself. The strip of material defines an upper portion which is equivalent to the horizontal base 70, side portions which are equivalent to the arms 72, 74, and a lower portion which spans the width of the lower surface 46b of the terminal contact plate 46. The strip of material may seat within the indents 66, 68 if provided.

In use, the contact interface 20 and the at least one retention member 50 are placed over adjacent battery cells (first battery cell 22 and second battery cell 22 are described herein for ease in explanation) such that the bottom surface 46b of the terminal contact plate 46 faces and is biased into contact with the respective terminals on the top surface 28a of the adjacent first and second battery cells 22 by the at least one biasing member 48. The at least one biasing member 48 provides force for reliable contact of the terminal contact plate 46 with the terminals. The legs 54, 56 of the bracket 44 abut against the side surfaces 26c, 26e of the package 26 and the appropriate engagements 38, 40 and 58, 60 are mated together. Once the contact interface 20 is secured to the first and second battery cells 22, the at least one retention member 50 may be removed from the bracket 44, the terminal contact plate 46 and the at least one biasing member 48. If the at least one retention member 50 impedes the ability of the at least one biasing member 48 to bias the terminal contact plate 46 into contact with the terminals, then the at least one retention member 50 is removed once the bracket 44, the terminal contact plate 46 and the at least one biasing member 48 are assembled with the adjacent first and second battery cells 22.

Assembly tools may be provided to disengage the bracket 44 from the engagements 38, 40 to aid in removing the contact interface 20 from the battery cells 22. If one or more of the battery cells 22 is/are replaced in the battery module, the same contact interface 20 can be reused with the replacement battery cell(s) 22.

An additional advantage of the contact interface 20 of the present disclosure is ease of assembly. The installation of the contact interface 20 could be automated. The process of pushing the contact interface 20 onto the assemblies 24 can be performed with simple tools or with robots, without the expense of welding systems and weld inspection equipment.

While particular embodiments are illustrated and described with respect to the drawings, it is envisioned that those skilled in the art may devise various modifications without departing from the spirit and scope of the appended claims. It will therefore be appreciated that the scope of the disclosure and the appended claims is not limited to the specific embodiments illustrated in and discussed with respect to the drawings and that modifications and other embodiments are intended to be included within the scope of the disclosure and the appended drawings. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure and the appended claims. Further, the foregoing descriptions describe methods that recite the performance of a number of steps. Unless stated to the contrary, one or more steps within a method may not be required, one or more steps may be performed in a different order than as described, and one or more steps may be formed substantially contemporaneously. Finally, the drawings are not necessarily drawn to scale.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

We claim:

1. A contact interface configured to be coupled to a pair of batteries, comprising:
a bracket including a base and a pair of legs extending from opposite ends of the base, each leg having an engagement provided thereon which is configured to be coupled to an engagement on each of the batteries;
a conductive terminal contact plate configured to be in contact with terminals on the batteries; and
a biasing member provided between the bracket and the terminal contact plate.

2. The contact interface as defined in claim 1, wherein the base includes a recess in a bottom surface thereof, and the biasing member seats within the recess.

3. The contact interface as defined in claim 1, wherein the biasing member is a spring.

4. The contact interface as defined in claim 1, wherein the engagements are projections that seat within recesses.

5. The contact interface as defined in claim 1, further including a retention member coupled to the bracket and to the terminal contact plate.

6. The contact interface as defined in claim 1, wherein the terminal contact plate has an indent in a lower surface thereof, wherein the retention member seats within the indent.

7. The contact interface as defined in claim 1, wherein a pair of biasing members are provided, and further including a pair of retention members coupled to the bracket and to the terminal contact plate.

8. The contact interface as defined in claim 7, wherein the terminal contact plate has a pair of indents in a lower surface thereof, wherein the retention members seat within the indents.

9. A contact interface configured to be coupled to a pair of batteries, comprising:
a bracket including a base and a pair of legs extending from opposite ends of the base, each leg having an engagement provided therein which is configured to be coupled to an engagement on each of the batteries, the base including a pair of recesses in a bottom surface thereof, the engagements on the brackets being one of cutout and a projection;
a conductive terminal contact plate configured to be in contact with terminals on the batteries; and
a pair of biasing members provided between the bracket and the terminal contact plate, the biasing members being seated within the recesses.

10. The contact interface as defined in claim 9, wherein the biasing members are springs.

11. The contact interface as defined in claim 9, further including a pair of retention members coupled to the bracket and to the terminal contact plate.

12. The contact interface as defined in claim 11, wherein the terminal contact plate has a pair of indents in a lower surface thereof, wherein the retention members seat within the indents.

13. An assembly comprising:
a pair of batteries, each battery comprising a positive terminal and a negative terminal on a top surface thereof, and each battery having at least one engagement on a side surface thereof; and
a contact interface comprising a bracket including a base and a pair of legs extending from opposite ends of the base, the base overlaying the top surfaces of the batteries, each leg having an engagement provided thereon which is configured to be coupled to one of the engagements on each battery, a conductive terminal contact plate in contact with one of the terminals on each battery, and a biasing member provided between the bracket and the terminal contact plate.

14. The assembly as defined in claim 13, wherein the base includes a recess in a bottom surface thereof, and the biasing member seats within the recess.

15. The assembly as defined in claim 13, wherein the biasing member is a spring.

16. The assembly as defined in claim 13, wherein the engagements are projections that seat within recesses.

17. The assembly as defined in claim 13, further including a retention member coupled to the bracket and to the terminal contact plate.

18. The assembly as defined in claim 13, wherein the terminal contact plate has an indent in a lower surface thereof, wherein the retention member seats within the indent.

19. The contact interface as defined in claim 13, wherein a pair of a biasing members are provided, and further including a pair of retention members coupled to the bracket and to the terminal contact plate.

20. The contact interface as defined in claim 19, wherein the terminal contact plate has a pair of indents in a lower surface thereof, wherein the retention members seat within the indents.
